(19) United States
(12) Patent Application Publication
(10) Pub. No.: US 2018/0084105 A1
(43) Pub. Date: Mar. 22, 2018

(54) DETERMINING A REGION OF A USER EQUIPMENT USING DIRECTIONAL RECEIVE ANTENNA ARRAYS

(71) Applicant: QUALCOMM Incorporated, San Diego, CA (US)

(72) Inventors: Paul Hiscock, Cambridge (GB); Nicolas Graube, Cambridge (GB)

(21) Appl. No.: 15/273,115

(22) Filed: Sep. 22, 2016

(51) Int. Cl. H04M 1/725; H04W 4/02; H01Q 1/22; H04W 4/04

(52) U.S. Cl. CPC H04M 1/72572; H04W 4/046; H01Q 1/2291; H04W 4/021

(57) ABSTRACT

In an embodiment, an apparatus measures, via a first directional receive antenna array and a second directional receive antenna array that are each coupled to an apparatus, one or more signals that are transmitted by one or more transmitters of the UE. The first and second directional receive antenna arrays are oriented at different directions. The apparatus determines first and second representative values for the first and second directional receive antenna arrays, respectively based on some or all of the measurements. The apparatus determines whether the UE is within a given region based on the first and second representative values.

### BACKGROUND

### 1. Field of the Disclosure

Embodiments relate to determining a region of a user equipment (UE) using directional receive antenna arrays.

### 2. Description of the Related Art

A region at which a device is located can affect a number of operations. For example, in a Passive-Entry/Passive-Start (PEPS) implementation, detection of a keyfob triggers different actions based on whether the keyfob is determined to be inside or outside of the vehicle (e.g., unlock the vehicle if the keyfob is outside the vehicle and start the vehicle if the keyfob is inside the vehicle). The inside/outside region determination for the keyfob is typically made by measuring the power of a 125 kHz induced magnetic field between coils located in the car and a coil held within the keyfob. Once calibrated, this approach can determine position with an accuracy of about ±5 cm. However, relying upon magnetic induction to determine proximity requires a number of high current/voltage coils being placed around the vehicle, the coils must be calibrated in the vehicle, the coils must be energized whenever the keyfob is in-range of the vehicle, the magnetic signal level is used to determine range and other device types (e.g., smart phones, etc.) do not necessarily include such coils.

In outdoor environments, many location-detection schemes rely upon signal strengths of radio frequency (RF) transmissions (e.g., Bluetooth, etc.) to determine device locations. However, such schemes do not typically have a level of precision that is suitable for indoor environments for various reasons, such as multipath effects, proximity to metal objects, polarization changes caused by reflection where a polarization of a transmitting antenna is unknown, and so on. In a specific example, a typical Received Signal Strength Indication (RSSI)-based location-detection system deployed within an indoor (or enclosed) environment can provide approximately 4-20 m of accuracy, which is higher than the above-noted magnetic coil approach that determines accuracy at about ±5 cm. Moreover, location-detection systems that are based on signal strength measurements may have similar issues in any environment that experiences multipath effects, and not merely indoor (or enclosed) environments.

### SUMMARY

An embodiment is directed to a method of determining a region of a user equipment (UE), including measuring, via a first directional receive antenna array coupled to an apparatus, one or more signals that are transmitted by one or more transmitters of the UE, measuring, via a second directional receive antenna array coupled to the apparatus, the one or more signals that are transmitted by the one or more transmitters, wherein the first and second directional receive antenna arrays are oriented at different directions, determining a first representative value for the first directional receive antenna array based on some or all of the measurements of the one or more signals by the first directional receive antenna array, determining a second representative value for the second directional receive antenna array based on some or all of the measurements of the one or more signals by the second directional receive antenna array and determining whether the UE is within a given region based on the first and second representative values.

Another embodiment is directed to an apparatus configured to determine a region of a UE, including a first directional receive antenna array capable of measuring one or more signals transmitted by one or more transmitters of the UE, a second directional receive antenna array capable of measuring the one or more signals transmitted by the one or more transmitters of the UE, wherein the first and second directional receive antenna arrays are oriented towards different directions, a communications interface coupled to the first directional receive antenna array and the second directional receive antenna array, and a processor coupled to the communications interface and configured to measure, via the first directional receive antenna array, one or more signals that are transmitted by one or more transmitters of the UE, measure, via the second directional receive antenna array, the one or more signals that are transmitted by the one or more transmitters, determine a first representative value for the first directional receive antenna array based on some or all of the measurements of the one or more signals by the first directional receive antenna array, determine a second representative value for the second directional receive antenna array based on some or all of the measurements of the one or more signals by the second directional receive antenna array and determine whether the UE is within a given region based on the first and second representative values.

Another embodiment is directed to an apparatus configured to determine a region of a UE, including means for measuring, via a first directional receive antenna array coupled to an apparatus, one or more signals that are transmitted by one or more transmitters of the UE, means for measuring, via a second directional receive antenna array coupled to the apparatus, the one or more signals that are transmitted by the one or more transmitters, wherein the first and second directional receive antenna arrays are oriented at different directions, means for determining a first representative value for the first directional receive antenna array based on some or all of the measurements of the one or more signals by the first directional receive antenna array, means for determining a second representative value for the second directional receive antenna array based on some or all of the measurements of the one or more signals by the second directional receive antenna array and means for determining whether the UE is within a given region based on the first and second representative values.

Another embodiment is directed to a non-transitory computer-readable medium containing instructions stored thereon, which, when executed by an apparatus configured to determine a region of a UE, cause the apparatus to perform operations, the instructions including at least one instruction configured to cause the apparatus to measure, via a first directional receive antenna array coupled to an apparatus, one or more signals that are transmitted by one or more transmitters of the UE, at least one instruction configured to cause the apparatus to measure, via a second directional receive antenna array coupled to the apparatus, the one or more signals that are transmitted by the one or more transmitters, wherein the first and second directional receive antenna arrays are oriented at different directions relative to a border between inside a given region and outside the given region, at least one instruction configured to cause the apparatus to determine a first representative value for the first directional receive antenna array based on some or all of the measurements of the one or more signals by the first directional receive antenna array, at least one instruction configured to cause the apparatus to determine a second representative value for the second directional receive antenna array based on some or all of the measurements of the one or more signals by the second directional receive antenna array and at least one instruction configured to cause the apparatus to determine whether the UE is within the given region based on the first and second representative values.

### BRIEF DESCRIPTION OF THE DRAWINGS

A more complete appreciation of embodiments of the disclosure will be readily obtained as the same becomes better understood by reference to the following detailed description when considered in connection with the accompanying drawings which are presented solely for illustration and not limitation of the disclosure, and in which:

FIG. 1 illustrates a region-detection system in accordance with an embodiment of the disclosure.

FIG. 2 illustrates an antenna pattern of a monopole antenna.

FIG. 3 by contrast illustrates an antenna pattern of a directional receive antenna array, with the antenna pattern being more sensitive to radiation from the right and less sensitive to radiation from the left.

FIG. 4 illustrates a differential spatial antenna array pair whereby two directional receive antenna arrays are deployed back-to-back with substantially non-overlapping antenna patterns in accordance with an embodiment of the disclosure.

FIG. 5 illustrates a differential spatial antenna array pair in accordance with another embodiment of the invention.

FIG. 6A illustrates a directional receive antenna array deployment within a vehicle in accordance with an embodiment of the disclosure.

FIG. 6B illustrates a directional receive antenna array deployment within an office building in accordance with an embodiment of the disclosure.

FIG. 7A illustrates a directional receive antenna array deployment in proximity to multiple interior regions of an enclosed area in accordance with an embodiment of the disclosure.

FIG. 7B illustrates the directional receive antenna array deployment being coupled to a controller in accordance with an embodiment of the disclosure.

FIG. 7C illustrates a directional receive antenna array deployment in proximity to multiple interior regions of a vehicle in accordance with an embodiment of the disclosure.

FIG. 7D illustrates a directional receive antenna array deployment in proximity to multiple interior regions of a conference room in accordance with an embodiment of the disclosure.

FIG. 8 illustrates a user equipment (UE) in accordance with embodiments of the disclosure.

FIG. 9 illustrates a process of determining whether a UE is within a region in accordance with an embodiment of the disclosure.

FIG. 10 illustrates an example implementation of the process of FIG. 9 in accordance with an embodiment of the disclosure.

FIG. 11 illustrates a communications device that includes structural components in accordance with an embodiment of the disclosure.

FIG. 12 illustrates a server in accordance with an embodiment of the disclosure.

### DETAILED DESCRIPTION

Aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the disclosure” does not require that all embodiments of the disclosure include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

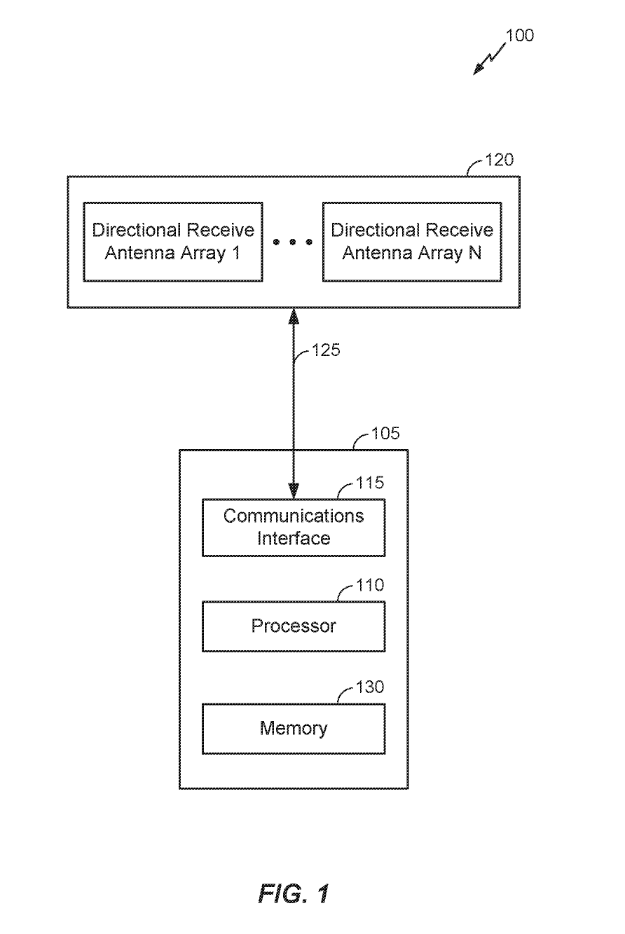

FIG. 1 illustrates a region-detection system 100 in accordance with an embodiment of the disclosure. The region-detection system 100 includes a controller 105 that includes a processor 110, a memory 130 and a communications interface 115. The communications interface 115 is coupled to a directional receive antenna array deployment 120 that includes a plurality of directional receive antenna arrays 1 . . . N, where N is an integer that is greater than or equal to 2 and each receive antenna array includes one or more antennas. While the directional receive antenna array is described herein as an “array,” it is understood that such an array can also include a single antenna in some embodiments.

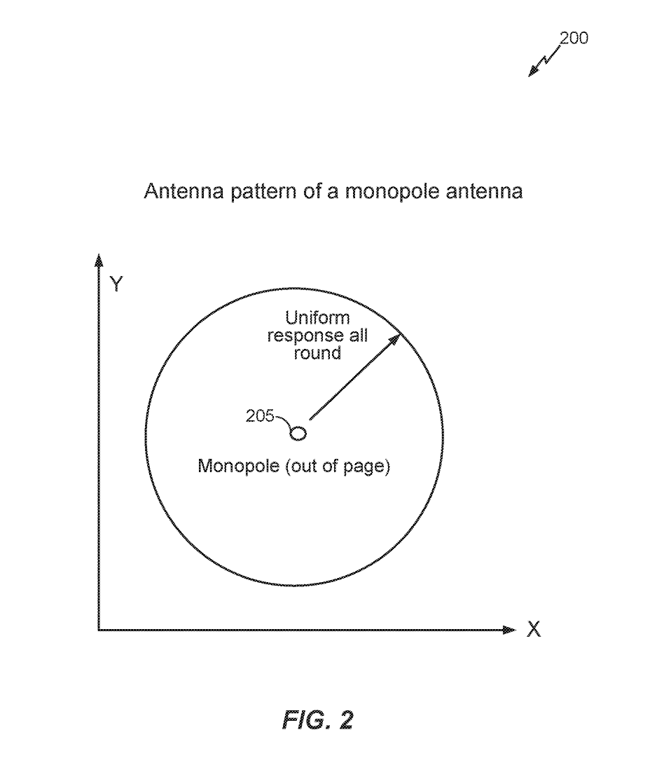

A coupling 125 between the communications interface 115 of the controller 105 and the directional receive antenna array deployment 120 may be wireless, wired or a combination thereof. In an example, each of the plurality of directional receive antenna arrays 1 . . . N may be configured with the same gain. In a specific example related to a wireless coupling, the directional receive antenna arrays 1 . . . N may be implemented as Bluetooth antenna arrays and the communications interface 115 may include a Bluetooth radio configured to measure Bluetooth signals received at the Bluetooth antenna arrays. Moreover, the coupling 125 need not be the same to each of the directional receive antenna arrays 1 . . . N (e.g., the communications interface 115 may be wirelessly coupled to directional receive antenna array 1 while having a wired connection to directional receive antenna array 2, etc.). Each of directional receive antenna arrays 1 . . . N includes one or more directional receive antennas that are each oriented in a particular direction so as to achieve a directional antenna pattern, as will be explained in more detail with respect to FIGS. 2-5.

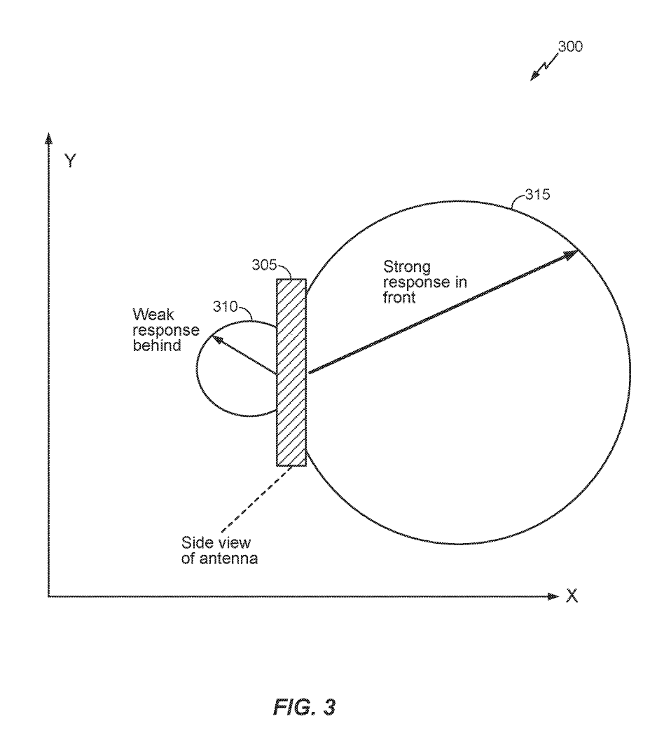

To provide context, FIG. 2 illustrates an antenna pattern 200 of a monopole antenna 205. The antenna pattern 200 has a uniform response in all directions around its center because the monopole transmitter (not shown) is omnidirectional. In FIG. 2, the X and Y axes represent location coordinates relative to a top-view of the monopole antenna 205, with the antenna pattern 200 indicating a degree to which the monopole antenna 205 is sensitive to signals arriving from different directions. FIG. 3 by contrast illustrates an antenna pattern 300 of a directional receive antenna array 305, with the antenna pattern 300 being more sensitive to radiation from the right and less sensitive to radiation from the left. In FIG. 3, the X and Y axes represent location coordinates relative to a side-view of the directional receive antenna array 305, with left antenna pattern beam 310 and right antenna pattern beam 315 indicating a degree to which the directional receive antenna array 305 is sensitive to signals arriving from left and right directions, respectively. In some embodiments, the right antenna pattern beam 315 includes a main lobe or beam and the left antenna pattern beam 310 includes a back lobe and/or side lobe. It is understood that the directional receive antenna array 305 illustrated in FIG. 3 may comprise a single antenna or may comprise multiple antennas. On their own, neither a monopole antenna nor a directional antenna can provide much location information using signal-levels alone.

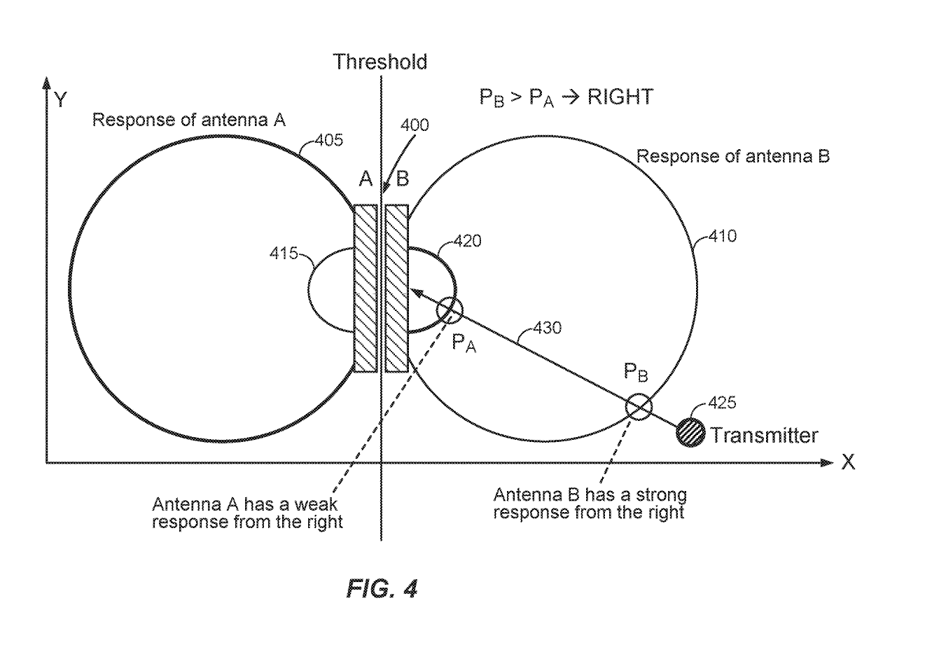

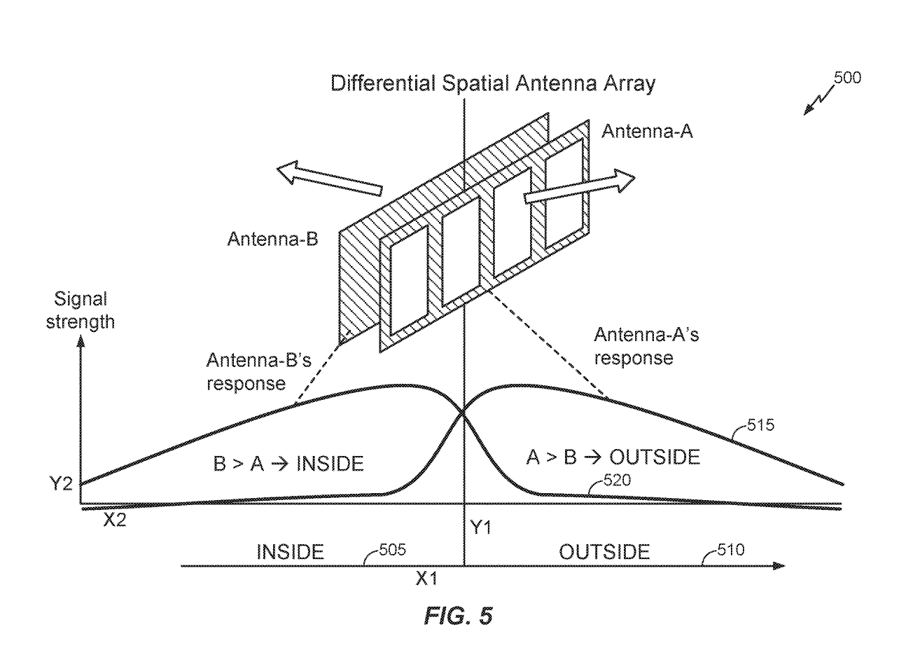

FIG. 4 illustrates a differential spatial antenna array pair 400 whereby two directional receive antenna arrays A and B are deployed back-to-back with substantially non-overlapping antenna pattern beams or lobes. Each of directional receive antenna arrays A and B can be single antennas or one or both may comprise multiple antennas, as depicted in the embodiment of FIG. 5. The pattern of each of directional receive antenna arrays A and B includes two lobes or beams, including antenna pattern beams 405 and 410, in accordance with an embodiment of the disclosure. In some embodiments, antenna pattern beam 405 is a main beam of the pattern of directional receive antenna array A, and antenna pattern beam 410 is a main beam of the pattern of directional receive antenna array B. As explained further below, it is understood that directional receive antenna arrays A and B may include additional beams in their respective antenna patterns than antenna pattern beams 405 and 410.

Similar to FIG. 3, the X and Y axes in FIG. 4 represent location coordinates relative to a side-view of the directional receive antenna A and B, with the respective antenna pattern beams indicating a degree to which the directional receive antenna arrays A and B are sensitive to signals arriving from left and right directions, respectively. In particular, directional receive antenna array A has a strong response (or more sensitivity) from the left as shown with respect to antenna pattern beam 405, and a weak response (or less sensitivity) from the right as shown with respect to smaller antenna pattern beam 420. Likewise, directional receive antenna array B has a strong response from the right as shown with respect to antenna pattern beam 410, and a weak response from the left as shown with respect to smaller antenna pattern beam 415. As can be seen from FIG. 4, antenna pattern beams 405 and 410 are substantially non-overlapping. As illustrated, beams 405 and 410 are oriented at about 180 degrees from each other. However, in other embodiments of substantially non-overlapping antenna pattern beams, the antenna pattern beams can be considered substantially non-overlapping if they are oriented at greater than 90 degrees from each other. Furthermore, an entire antenna pattern of one directional receive antenna array can be considered substantially non-overlapping with respect to another directional receive antenna array in at least one embodiment.

As used herein, “substantially” non-overlapping does not mean completely non-overlapping, as antenna pattern beam 415 overlaps with antenna pattern beam 405 and antenna pattern beam 420 likewise overlaps with antenna pattern beam 410. In one example, antenna patterns are substantially non-overlapping if the main beams of the respective antenna patterns are themselves substantially non-overlapping. In another example, antenna patterns are substantially non-overlapping if a majority of the respective antenna patterns of the directional receive antenna arrays A and B are non-overlapping as will be appreciated by one of ordinary skill in the art. A percentage threshold (e.g., 70%, 80%, 90%, 95%, etc.) above which antenna patterns qualify as “substantially” non-overlapping can vary by implementation.

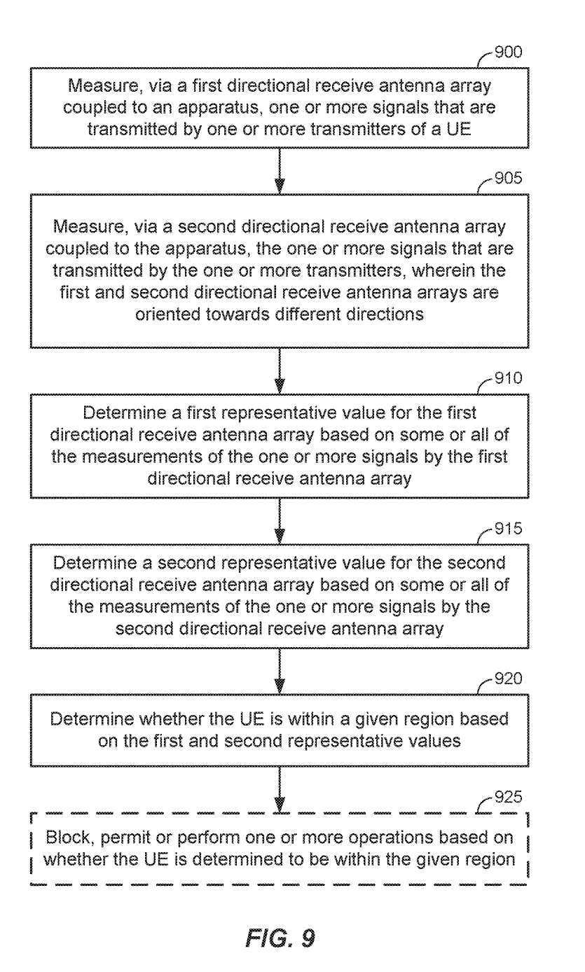

In FIG. 4, a transmitter 425 is positioned on the right of the differential spatial antenna array pair 400, with the transmitter 425 transmitting a signal 430. The signal 430 is detected by directional receive antenna array B at point P_{B} where the signal 430 intersects with the antenna pattern beam 410, whereas the signal 430 is detected by directional receive antenna array A at point P_{A} where the signal 430 intersects with the antenna pattern beam 420, which results in a stronger response (or stronger detection) of the signal 430 by the directional receive antenna array B. In an environment where the polarization of the transmitter 425 is known and/or where multipath effects are low, the stronger response of the directional receive antenna array B on the right side can permit detection of the transmitter 425 as positioned on the right side of the differential spatial antenna array pair 400. However, it will be appreciated that a multipath component of the signal 430 could make it appear as if the transmitter 425 was on the left side of the differential spatial antenna array pair 400 if the multipath component cannot be identified as a multipath effect based on a polarization characteristic, as will be described in more detail below with respect to FIG. 9.

FIG. 5 illustrates a differential spatial antenna array pair 500 in accordance with another embodiment of the invention. In FIG. 5, the differential spatial antenna array pair 500 is illustrated as comprising two directional receive antenna arrays A and B that are each equipped with multiple antennas, although the description below with reference to FIG. 5 may apply in embodiments where one or more of the directional receive antenna arrays A and B include a single antenna. In FIG. 5, the differential spatial antenna array pair 500 is depicted more specifically with respect to indoor and outdoor regions relative to an enclosed area. The X1 axis represents location coordinates relative to a side-view of the directional receive antenna arrays A and B, whereas the Y1 axis represents the location at which the differential spatial antenna array pair 500 is deployed. In FIG. 5, the Y1 axis is further aligned along a border zone between an indoor region (i.e., inside) and an outdoor region (i.e., outside). Hence, portion 505 of the X1 axis is inside of an enclosed area, whereas portion 510 of the X1 axis is outside of the enclosed area. The X2 axis is similar to the X1 axis in terms of representing location coordinates relative to a side-view of the directional receive antenna arrays A and B. The Y2 axis represents a signal response level for each directional receive antenna array, which is a combination of the received signals from each antenna element in the directional receive antenna array. For example, FIG. 5. shows a directional receive antenna array with four antennas (or antenna elements). The signal response level may be combined by averaging the individual received signal levels from each antenna element. Alternatively, if an antenna calibration is known for each antenna element, the individual received signal levels from each antenna element may be suitably pre-scaled to normalize the received signal, before averaging. Line 515 represents the signal response level of the directional receive antenna array A inside and outside of the enclosed area, whereas line 520 represents the signal response level of the directional receive antenna array B inside and outside of the enclosed area. As shown in FIG. 5, the directional receive antenna array A is more sensitive to signals received from transmitters in the outside region, whereas the directional receive antenna array B is more sensitive to signals received from transmitters in the inside region.

With respect to FIG. 5, near the Y1 axis, the signal response levels of the directional receive antenna arrays A and B are similar. This is partly due to the practical separation of the antennas and also the multipath environment. In an example, each inside/outside decision can have an associated confidence level. This confidence level may be a function of the two received signal levels measured via the directional receive antenna arrays A and B and also a calibration factor (e.g., which may be predetermined) associated with directional receive antenna arrays A and B for a particular multipath environment.

While FIGS. 3-5 have been described above with respect to two directional receive antenna arrays (i.e., directional receive antenna arrays A and B), it will be appreciated that other embodiments of the disclosure may be directed to any number of directional receive antenna arrays.

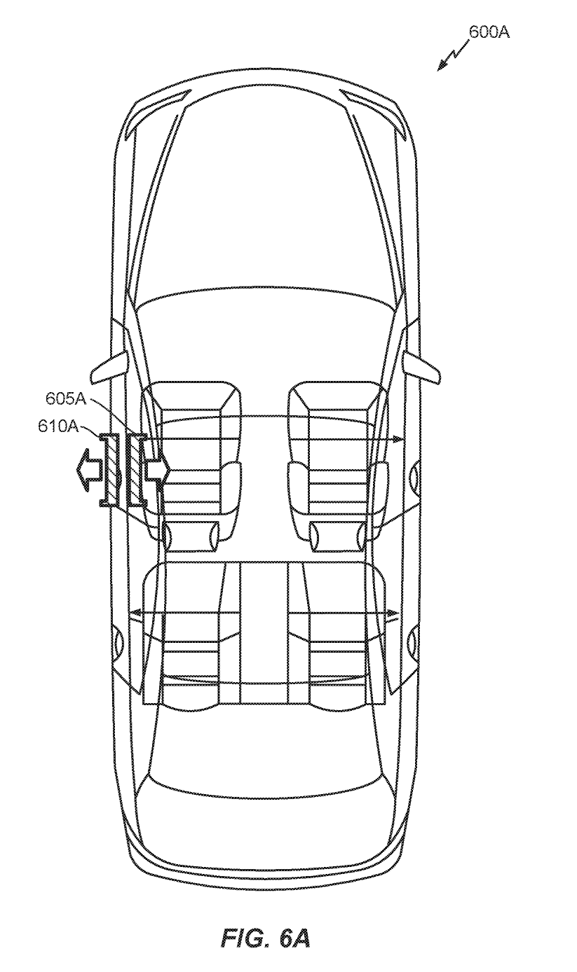

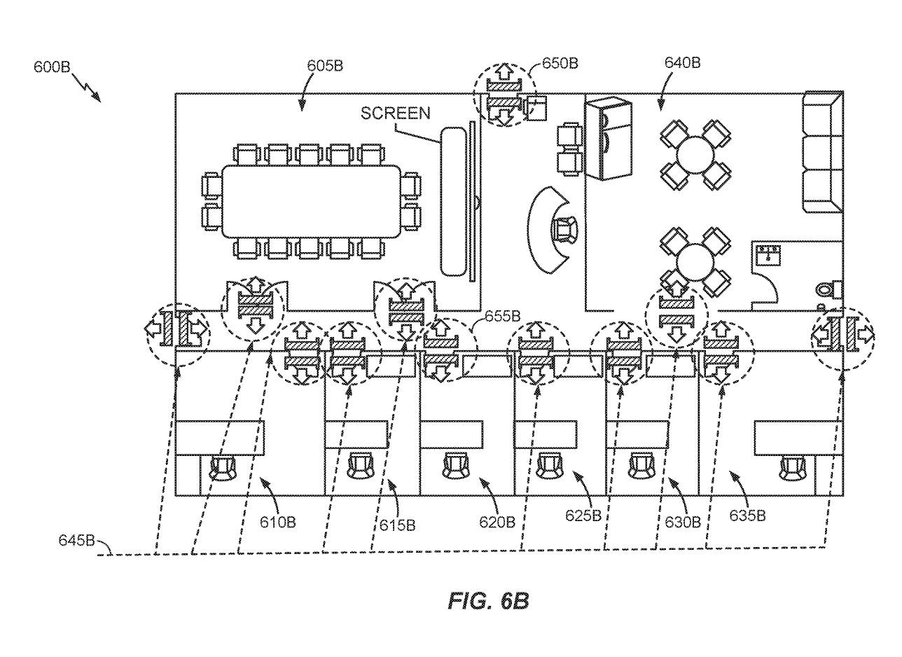

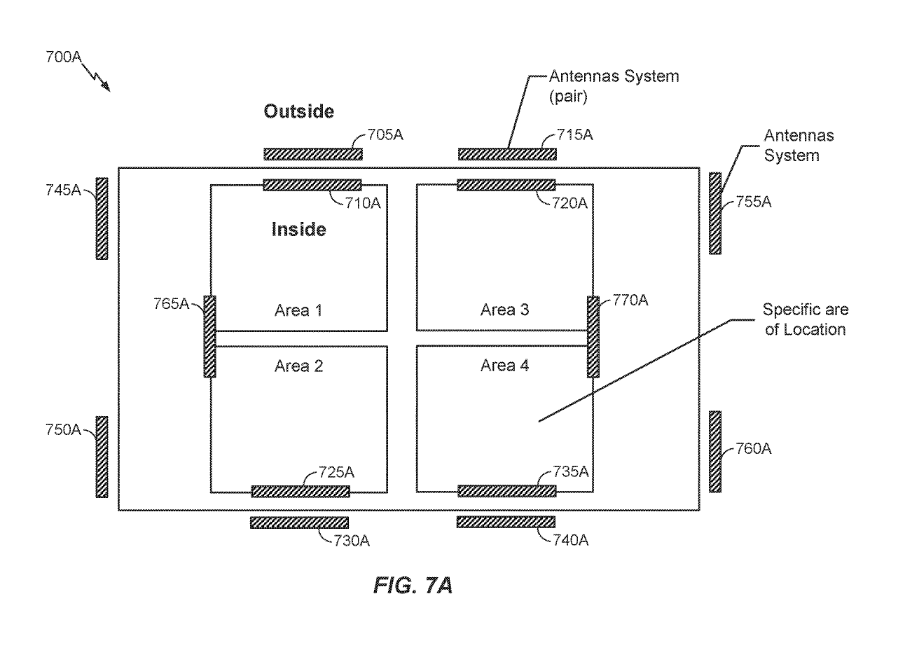

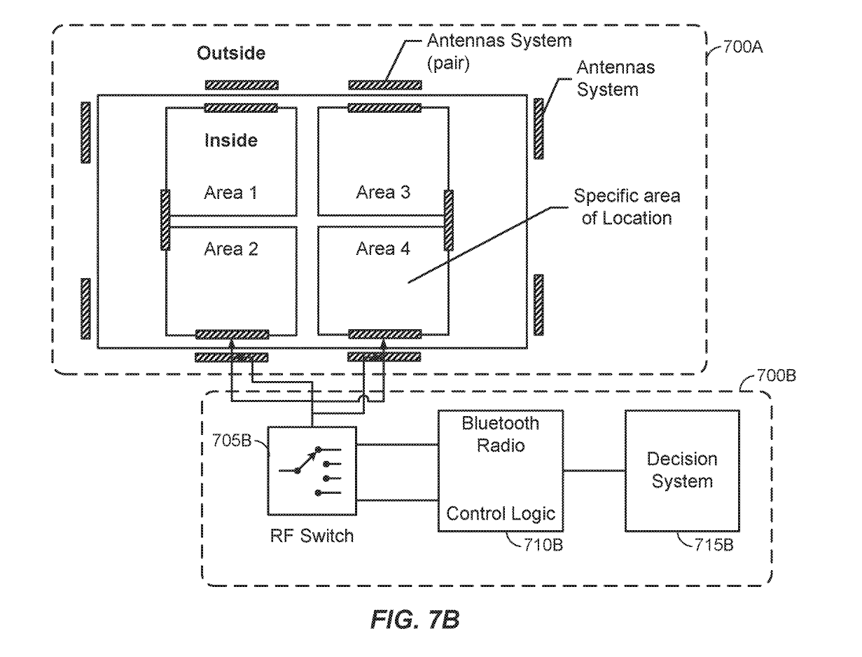

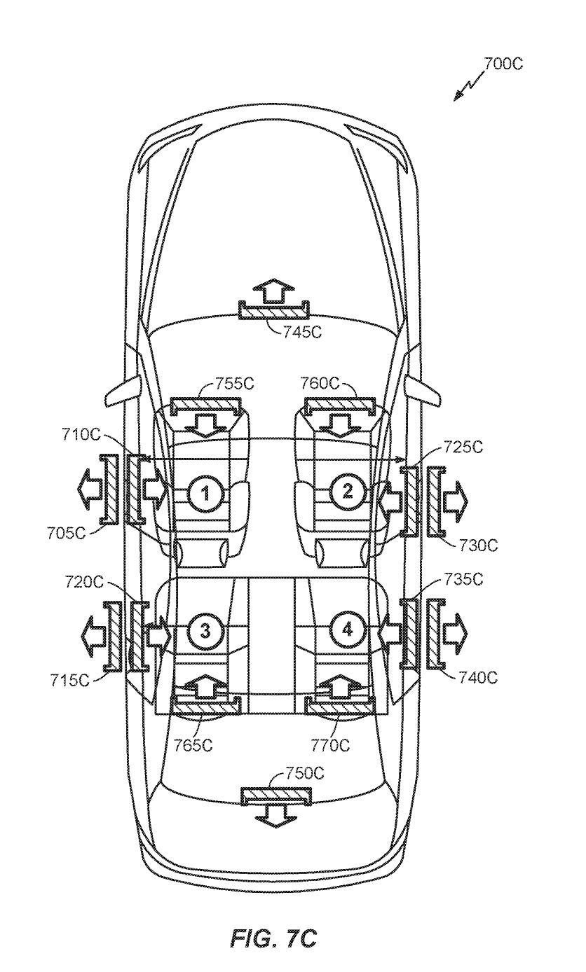

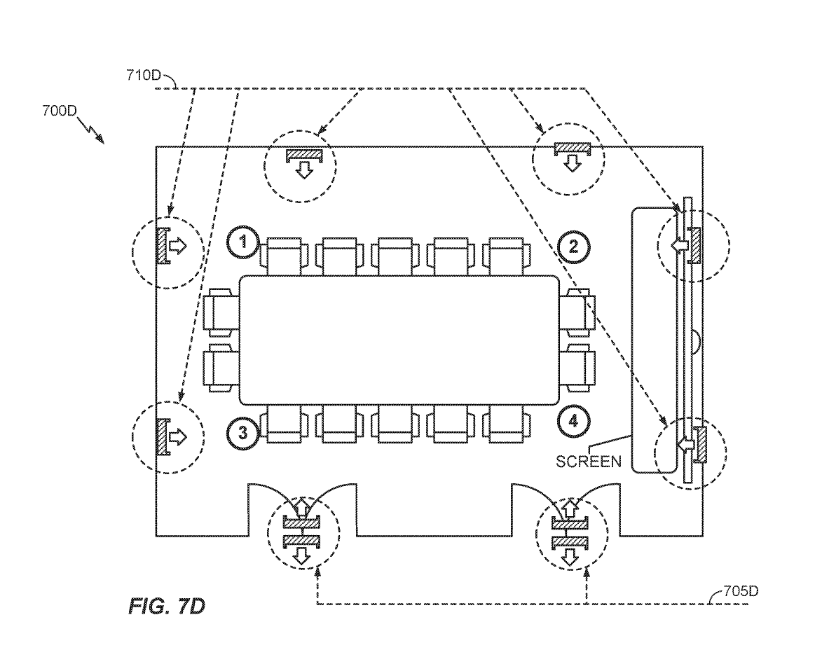

FIGS. 6A-7D illustrate a number of different directional receive antenna array deployment examples in accordance with embodiments of the disclosure. In particular, FIGS. 6A-6B illustrate directional receive antenna array deployment examples related specifically to indoor-outdoor region determination, whereas FIGS. 7A-7D illustrate various directional receive antenna array deployment examples related to region determination inside of an enclosed (or indoor) environment.

FIG. 6A illustrates a directional receive antenna array deployment within a vehicle 600A in accordance with an embodiment of the disclosure. Referring to FIG. 6A, a first directional receive antenna array 605A and a second directional receive antenna array 610A are deployed back-to-back in proximity to a driver-side door of the vehicle 600A. The first and second directional receive antenna arrays 605A, 610A are both capable of measuring one or more signals transmitted by one or more transmitters of, for example, a UE which can be a keyfob or a mobile device such as a smart phone. The first and second directional receive antenna arrays 605A and 610A are configured similarly to the differential spatial antenna array pairs 400 and 500, with the first directional receive antenna array 605A being configured with a stronger signal response for signals from a region outside the vehicle 600A and the second directional receive antenna array 610A being configured with a stronger signal response for signals from a region inside of the vehicle 600A. In particular, the arrows illustrated in association with the first and second directional receive antenna arrays 605A and 610A in FIG. 6A indicate the directions at which their respective antenna patterns are oriented. As used herein, the orientation of an antenna pattern refers to the direction at which a given directional receive antenna array will have a higher response than an opposite direction (or a direction that is offset by 180 degrees from the direction of orientation). Hence a directional receive antenna array with a main lobe to the right representing a higher response of the antenna to signals received from the right and a back lobe to the left representing a response to signals received from the left that is lower than the response represented by the main lobe will be considered oriented to the right. While not shown expressly in FIG. 6A, the first and second directional receive antenna arrays 605A and 610A may be coupled to a controller (e.g., controller 105 of FIG. 1, which may be inside of the vehicle 600A) via either a wired or wireless connection. As used herein, the terminology of indoor and outdoor is not intended to be interpreted in an absolute sense but rather in a relative sense (e.g., a region outside the vehicle 600A is considered an “outside” region even if the vehicle is inside a parking garage or other structure).

FIG. 6B illustrates a directional receive antenna array deployment within an office building 600B in accordance with an embodiment of the disclosure. The office building 600B includes a conference room 605B, offices 610B-635B and a kitchen 640B. A plurality of differential spatial antenna array pairs 645B-655B are implemented at various indoor-outdoor border areas throughout the office building 600B. While not numbered individually for the sake of clarity, each differential spatial antenna array pair 645B-655B includes a first directional receive antenna array being configured with a stronger signal response for signals from an outside region, and a second directional receive antenna array being configured with a stronger signal response for signals from an inside region. Similar to FIG. 6A, the arrows illustrated in association with each directional receive antenna array indicate a direction in which its respective antenna pattern is oriented. In FIG. 6B, indoor and outdoor regions are relative to each indoor-outdoor border area, such that the differential spatial antenna array pair 655B at the doorway into office 620B differentiates between signals from inside or outside the office 620B, whereas differential spatial antenna array pair 650B differentiates between signals from inside or outside the office building 600B itself. Once again, the terminology of indoor and outdoor is not intended to be interpreted in an absolute sense but rather in a relative sense (e.g., the hallway outside the office 615B is “outside” in context with the differential spatial antenna array pair 645B deployed at that particular doorway, even though this hallway is still inside of the office building 600B). While not shown expressly in FIG. 6B, the plurality of differential spatial antenna array pairs 645B-655B may be coupled to a controller (e.g., controller 105 of FIG. 1) via either a wired or wireless connection. For example, the controller in FIG. 6B may correspond to a local or remote server, as an example.

FIG. 7A illustrates a directional receive antenna array deployment 700A in proximity to multiple interior regions of an enclosed area in accordance with an embodiment of the disclosure. In FIG. 7A, the interior regions of the enclosed area are marked as Area 1, Area 2, Area 3, and Area 4. The directional receive antenna array deployment of FIG. 7A includes directional receive antenna arrays 705A-740A, which are implemented as differential spatial antenna array pairs where paired directional receive antenna arrays are deployed back-to-back with respective antenna patterns oriented towards inside or outside regions. The directional receive antenna array deployment 700A of FIG. 7A further includes directional receive antenna arrays 745A-770A which are not paired with another directional receive antenna array in a differential spatial antenna array pair configuration. Rather, directional receive antenna arrays 745A-760A are deployed with antenna patterns oriented towards the outside region, whereas directional receive antenna arrays 765A-770A are oriented towards particular areas of the inside region. The indoor-oriented directional receive antenna arrays 710A, 720A, 725A, 735A, 765A and 770A may be used to help determine a particular interior area where a transmitter is located.

FIG. 7B illustrates the directional receive antenna array deployment 700A being coupled to a controller 700B in accordance with an embodiment of the disclosure. The controller 700B includes an RF switch 705B, a Bluetooth radio 710B configured with control logic and a decision system 715B.

Referring to FIG. 7B, in an embodiment, the RF switch 705B selects each directional receive antenna array in order and uses a single Bluetooth Radio to perform the signal measurements. As illustrated, both Area 2 and Area 4 each have a pair of directional receive antenna arrays, each pair including a first directional receive antenna array and a second directional receive antenna array. RF switch 705B can be configured to tune to one of the first and second directional receive antenna arrays to facilitate the signal measurements. This approach avoids radio calibration issues that could arise in a multi-radio solution as well as higher costs associated with the additional radio(s), although other embodiments can be directed towards a multi-radio solution with radio calibration, if deemed appropriate. In an example, the Bluetooth radio 710B controls the RF switch 705B sequencing using standard Bluetooth v5.0 Angle of Arrival (AoA)/Angle of Departure (AoD) protocols to acquire the information about a signal received by a respective antenna array from a proximate transmitter (for AoA) or to acquire the information about a signal transmitted by a respective antenna array to a proximate receiver (for AoD). In addition to applying conventional AoA/AoD algorithms to the measured signal(s), multiple signal-level measurements may be made, spatially within each antenna array, and over multiple frequencies to counter multipath effects. In addition, data is combined from each antenna array to mitigate polarization. For example, polarization may be mitigated by deploying separate (or additional) antenna elements within one or more of the antenna arrays that are sensitive to different types of polarization, with the signal measurements from each respective differently-polarized antenna element being combined in some manner and then used as a representative measurement for that antenna array.

Referring to FIG. 7B, in a further embodiment, the transmitter (e.g., a smartphone or keyfob) may be located in one of a number of areas outside the enclosed area (not shown in FIG. 7B). The directional receive antenna arrays used to measure signals from the outside-located transmitter in this scenario may correspond to one or more (e.g., less than all, all, etc.) available outside-located directional receive antenna arrays, one or more (e.g., less than all, all, etc.) of the inside-located directional receive antenna arrays, or any combination thereof (e.g., both indoor-located and outdoor-located directional receive antenna arrays).

Referring to FIG. 7B, in a further embodiment, beam-forming techniques can be used to sub-divide a particular region into smaller parts. For example, a single directional receive antenna array could operate over 180 degrees (and benefit from spatial diversity averaging by combining signals from all antenna elements), or the single directional receive antenna array could be split into two regions of 90 degrees (in this case less spatial averaging can be performed for each respective region), etc. So, while beam-forming depicted in FIG. 7B generally shows a 180 degree range for each directional receive antenna array, this can be controlled to achieve any target degree range so as to define any custom region size (or shape) in other embodiments of the disclosure. For example, in FIG. 7B, the beam-forming of antenna patterns of particular directional receive antenna arrays may be configured to conform to one of Areas 1-4 (e.g., a driver's seat area, a passenger seat area, etc.).

Referring to FIG. 7B, in a further embodiment, the phase and amplitude measurements from each directional receive antenna array are correlated against a reference data set. In an example, the reference data set may refer to calibration data obtained in a vicinity of the enclosed area depicted in FIG. 7A that may remove (or cancel out) signal interactions with local materials or obstructions, which can be referred to as local multipath or antenna interactions The region associated with the largest correlated result is reported. This approach can include a pre-calibration phase, where the amplitude and phase measurements are taken from each directional receive antenna array at multiple positions within each region using a transmitter with known polarization. This process is repeated with different transmit polarizations and at different frequencies. This approach has the benefit of removing some of the local effects due to antenna interactions that may exist due to local materials near the directional receive antenna arrays and between the directional receive antenna arrays themselves.

FIG. 7C illustrates a directional receive antenna array deployment in proximity to multiple interior regions (labeled in FIG. 7C as 1-4) of a vehicle 700C in accordance with an embodiment of the disclosure. The directional receive antenna array deployment depicted in FIG. 7C is an example implementation of the directional receive antenna array deployment 700A of FIG. 7A.

Referring to FIG. 7C, a first directional receive antenna array 705C and a second directional receive antenna array 710C are deployed back-to-back in proximity to a driver-side door (as customary in the United States) of the vehicle 700C, similar to the first and second directional receive antenna arrays 605A-610A of FIG. 6A. The directional receive antenna array deployment of FIG. 7C further includes at least one additional directional receive antenna array, for example, directional receive antenna arrays 715C-770C, deployed throughout the interior and exterior of the vehicle 700C. As shown, the multiple directional receive antenna arrays among directional receive antenna arrays 715C-770C are deployed throughout a perimeter of the vehicle 700C. The arrows illustrated in association with the directional receive antenna arrays 705C-770C in FIG. 7C indicate the directions at which their respective antenna patterns are oriented. While not shown expressly in FIG. 7C, the directional receive antenna arrays 705C-770C may be coupled to one or more controllers (e.g., controller 105 of FIG. 1, which may be inside of the vehicle 700C) via either a wired or wireless connection. As noted above, outdoor quadrants (or areas) could also be defined, such as “in front of the vehicle”, “left of the vehicle”, “behind the vehicle” and “right of the vehicle”, such that the embodiment of FIG. 7C is not necessarily limited to identifying a transmitter location in a specific interior region of the vehicle 700C but could also encompass identifying a transmitter location in a specific exterior region of the vehicle 700C as well. Hence, in this embodiment, it is possible to determine whether a transmitter is within a given region, where the given region corresponds to either an interior of the vehicle, an exterior of the vehicle, or to a particular portion of the interior or exterior of the vehicle.

As will be appreciated from a review of FIGS. 6A and 7C, FIG. 7C represents a directional receive antenna array deployment that includes additional directional receive antenna arrays relative to the directional receive antenna array deployment in FIG. 6B. In addition to providing the capacity to characterize the location of the transmitter in terms of sub-region (or quadrant) of an interior or exterior space relative to the vehicle, the directional receive antenna array deployment of FIG. 7C may also be used to increase a confidence level associated with an indoor/outdoor determination relative to the directional receive antenna array deployment of FIG. 6A. For example, in the deployment of FIG. 6A, directional receive antenna arrays 605A and 610A can determine whether the transmitter is to the left of the directional receive antenna array 610A or to the right of the directional receive antenna array 605A. If the transmitter is determined to be to the right of the directional receive antenna array 605A, there is an indication with some confidence that the transmitter is inside the vehicle 600A. However, the transmitter may still be to the right of the directional receive antenna array 605A, yet be outside the vehicle 600A if the transmitter is to the right of a door on the right side of the vehicle 600A. However, the deployment of FIG. 7C can improve the confidence of a determination that the transmitter is inside the vehicle. For example, if the differential spatial antenna array pair 705C and 710C indicates that the transmitter is to the right of array 710C, while the differential spatial antenna array pair 725C and 730C indicates that the transmitter is to the left of array 725C, then the transmitter can be determined to be inside the vehicle with a higher level of confidence relative to the deployment of FIG. 6A. Further still, a stronger detection of the transmitter signal by the directional receive antenna array 755C with an antenna pattern predominately inside of the vehicle 700C relative to the directional receive antenna array 745C with an antenna pattern predominately outside of the vehicle 700C may function to increase a confidence level that the transmitter is inside the vehicle 700C even further relative to determinations by the differential spatial antenna array pairs 705C, 710C and 725C, 730C without the directional receive antenna arrays 745C, 755C.

FIG. 7D illustrates a directional receive antenna array deployment in proximity to multiple interior regions of a conference room 700D in accordance with an embodiment of the disclosure. The conference room 700D may correspond to the conference room 605B of FIG. 6B with additional directional receive antenna arrays deployed therein. The directional receive antenna array deployment depicted in FIG. 7D represents a variation of the directional receive antenna array deployment 700A of FIG. 7A, whereby directional receive antenna arrays are deployed so as to identify a transmitter presence in a specific interior region (labeled in FIG. 7D as 1-4).

Referring to FIG. 7D, directional receive antenna arrays 705D are deployed back-to-back in proximity to entrance doors to the conference room 700D, similar to the directional receive antenna arrays 645B in FIG. 6B in proximity to the conference room 605B. The directional receive antenna array deployment of FIG. 7D further includes directional receive antenna arrays 710D deployed throughout the interior of the conference room 700D. The arrows illustrated in association with the directional receive antenna arrays 705D-710D in FIG. 7D indicate the directions at which their respective antenna patterns are oriented. Unlike directional receive antenna arrays 705D, which are paired (or implemented as a differential spatial antenna array pair), the directional receive antenna arrays 710D are unpaired, with each direction receive antenna array 710D oriented in a different direction and/or installed at a different location within an enclosed environment (illustrated as conference room 700D). As illustrated, the directional receive antenna arrays 710D include a first and second directional receive antenna arrays where at least some of the substantially non-overlapping antenna patterns of the first and second directional receive antenna arrays cover different regions of an enclosed environment. While not shown expressly in FIG. 7D, the directional receive antenna arrays 705D-770D may be coupled to a controller (e.g., controller 105 of FIG. 1, which may correspond to a local or remote server) via either a wired or wireless connection.

Reference above is made to using the various directional receive antenna array deployments to identify a location of a transmitter. In embodiments of the disclosure, the transmitter corresponds to a user equipment (UE), which may also be referred to interchangeably as an “access terminal” or “AT”, a “wireless device”, a “subscriber device”, a “subscriber terminal”, a “subscriber station”, a “user terminal” or UT, a “mobile device”, a “mobile terminal”, a “mobile station”, a keyfob and variations thereof. In some embodiments, UEs can communicate with a core network via a radio access network (RAN), and through the core network the UEs can be connected with external networks such as the Internet. Of course, other mechanisms of connecting to the core network and/or the Internet are also possible for the UEs, such as over wired access networks, Wi-Fi networks (e.g., based on IEEE 802.11, etc.) and so on. UEs can be embodied by any of a number of types of devices including but not limited to cellular telephones, personal digital assistants (PDAs), pagers, laptop computers, desktop computers, printed circuit (PC) board cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel. Other types of UEs may only be configured for local wireless connectivity (e.g., Bluetooth, etc.), such that UEs need not have the above-noted functionality to be connected to the RAN and/or the Internet.

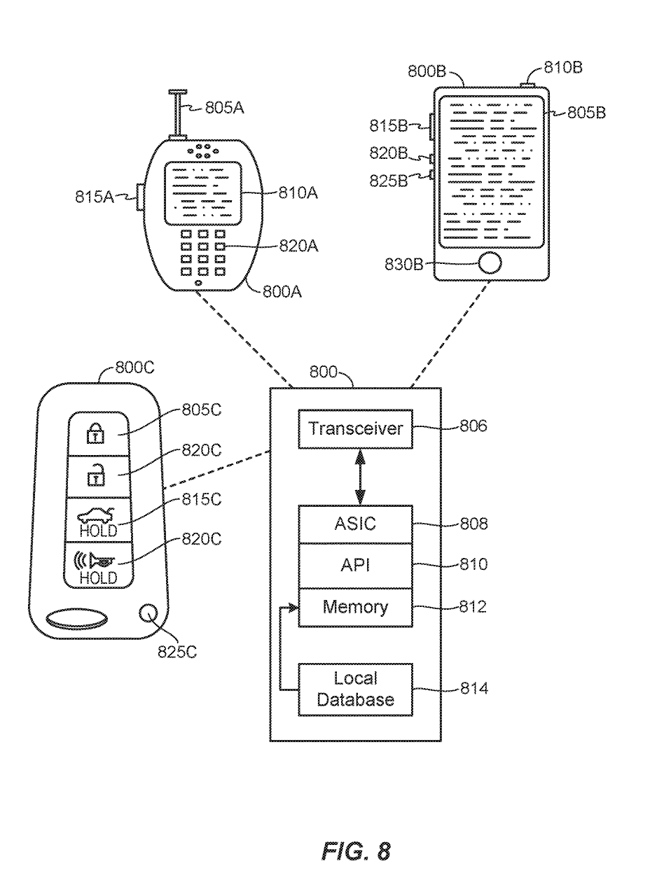

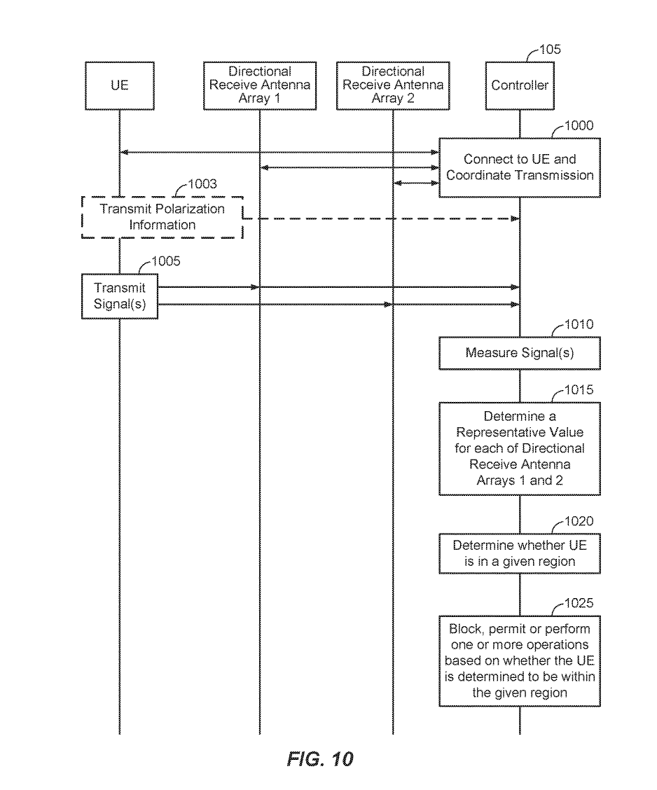

FIG. 8 illustrates a UE 800 in accordance with embodiments of the disclosure. Different variants of UE 800 are depicted in FIG. 8 with respect to UEs 800A-800C. In particular, UE 800A is a calling telephone, UE 800B is a touchscreen device (e.g., a smart phone, a tablet computer, etc.) and UE 800C is a keyfob. The UE 800 of FIG. 8 may correspond to any of the UEs described below with respect to FIGS. 9 and 10, for example, or it may correspond to a UE associated with a transmitter 425 referenced in FIG. 4, above.

While internal components of UE 800 can be embodied with different hardware configurations, a basic high-level UE configuration for internal hardware components may include a transceiver 806 operably coupled to an application specific integrated circuit (ASIC) 808, or other processor, microprocessor, logic circuit, or other data processing device. The ASIC 808 or other processor executes an application programming interface (API) 810 layer that interfaces with any resident programs in a memory 812 of the wireless device. The memory 812 can be comprised of read-only memory (ROM) or random-access memory (RAM), EEPROM, flash cards, or any memory common to computer platforms. UE 800 may also include a local database 814 that can store applications not actively used in the memory 812, as well as other data. The local database 814 is typically a flash memory cell, but can be any secondary storage device as known in the art, such as magnetic media, EEPROM, optical media, tape, soft or hard disk, or the like.

Accordingly, an embodiment of the disclosure can include a UE with the ability to perform the functions described herein. As will be appreciated by those skilled in the art, the various logic elements can be embodied in discrete elements, software modules executed on a processor or any combination of software and hardware to achieve the functionality disclosed herein. For example, the ASIC 808, the memory 812, the API 810 and the local database 814 may all be used cooperatively to load, store and execute the various functions disclosed herein and thus the logic to perform these functions may be distributed over various elements. Alternatively, the functionality could be incorporated into one discrete component.

Referring to FIG. 8, UE 800A is configured with an antenna 805A, a display 810A, at least one button 815A (e.g., a push-to-talk (PTT) button, a power button, a volume control button, etc.) and a keypad 820A among other components, as is known in the art. Also, UE 800B comprises an external casing which includes configured with a touchscreen display 805B, peripheral buttons 810B, 815B, 820B and 825B (e.g., a power control button, a volume or vibrate control button, an airplane mode toggle button, etc.), and at least one front-panel button 830B (e.g., a Home button, etc.), among other components, as is known in the art. UE 800C is configured with a lock button 805C, an unlock button 810C, a trunk release button 815C, a panic button 820C and a key release button 825C. While not shown explicitly as part of UE 800B, UE 800B and UE 800C can include one or more external antennas and/or one or more integrated antennas that are built into their respective casings, including but not limited to Wi-Fi antennas, cellular antennas, satellite position system (SPS) antennas (e.g., global positioning system (GPS) antennas), local RF antennas (e.g., Bluetooth, etc.), and so on.

With respect to FIG. 8, it will be appreciated that the various UE types represented by UEs 800A-800C can be implemented in various embodiments of the disclosure in different ways. For example, if the UE is implemented as a keyfob 800C, the keyfob 800C may be used to open and/or lock a vehicle (e.g., vehicle 600A of FIG. 6A or 700C of FIG. 7C) by transmitting one or more signals as described in detail with reference to FIG. 9, or connects to controller 105 (block 1000) and transmits signal(s) (block 1005) as described in detail with reference to FIG. 10. In another example, if the UE is implemented as a calling telephone 800A, or a touchscreen device 800B (e.g., a smart phone), the calling telephone 800A or touchscreen device 800B may download an application that, upon execution, transmits the one or more signals as described in detail with reference to FIG. 9, or connects to controller 105 (block 1000) and transmits signal(s) (block 1005) as described in detail with reference to FIG. 10.

FIG. 9 illustrates a process of determining whether a UE is within a region in accordance with an embodiment of the disclosure. In an example, the process of FIG. 9 may be performed by an apparatus (e.g., controller 105 of FIG. 1) with respect to any of the directional receive antenna array deployments discussed above with respect to FIGS. 7A-7D.

Referring to FIG. 9, the apparatus measures, via a first directional receive antenna array coupled to an apparatus, one or more signals that are transmitted by one or more transmitters of the UE, 900. The apparatus also measures, via a second directional receive antenna array coupled to the apparatus, the one or more signals that are transmitted by the one or more transmitters, wherein the first and second directional receive antenna arrays are oriented towards different directions (e.g., to achieve substantially non-overlapping antenna patterns), 905. In an example, the one or more signals may comprise one or more Wi-Fi signals, one or more cellular signals, or one or more local RF signals (e.g., Bluetooth, etc.). In a Bluetooth-specific example, the measurements at 900 and 905 may be made at a Bluetooth radio of the apparatus. In an example, the different directions towards which the first and second directional receiver antenna arrays are oriented may be relative to a border between inside a given region and outside the given region. In a further example, the border between inside the given region and outside the given region may correspond to a physical partition that defines an enclosed environment, such as a car door or an office door. In this case, the measurements of 900-905 can be used to determine (at 920, discussed below in more detail) whether a current region of the UE corresponds to inside or outside of the enclosed environment. In an alternative example, the border between inside the given region and outside the given region may correspond to a virtual partition that defines different regions or sub-regions of an outdoor or indoor environment (e.g., separations between vehicle seat areas that collectively occupy the interior space of a vehicle without physical dividers between the vehicle seat areas, etc.).

Referring to 900 of FIG. 9, in an example, a first antenna pattern of the first directional receive antenna array is defined based on beam-forming techniques to have a first degree of spatial coverage, a second antenna pattern of the second directional receive antenna arrays is defined based on beam-forming techniques to have a second degree of spatial coverage, and the given region is defined in part by the first and second degrees of coverage. For example, the first and/or second degrees of coverage may correspond to 90 degrees, or the first and/or second degrees of coverage may correspond to 180 degrees. In other examples, any target degree range can of antenna pattern coverage can be obtained via the aforementioned beam-forming techniques.

Accordingly, a particular area of antenna pattern coverage can be configured to comply with various design parameters (e.g., covering particular seating areas in the interior of a vehicle, covering particular quadrants outside of a vehicle such as back-of-car, or front-of-car, etc.).

Referring to FIG. 9, the apparatus determines a first representative value for the first directional receive antenna array based on some or all of the measurements of the one or more signals by the first directional receive antenna array, 910, and the apparatus also determines a second representative value for the second directional receive antenna array based on some or all of the measurements of the one or more signals by the second directional receive antenna array, 915. The apparatus determines whether the UE is within a given region based on the first and second representative values, 920. Based on the determination of 920, the apparatus optionally blocks, permits or performs one or more operations, 925.

Referring to FIG. 9, in an example, determination of the first representative value at 910 may include obtaining a first vertically polarized signal measurement and a first horizontally polarized signal measurement for each of the one or more signals via the first directional receive antenna, with each of the measurements of the one or more signals by the first directional receive antenna array used to determine the first representative value corresponding to a larger of the first vertically polarized signal measurement and the first horizontally polarized signal measurement or an average of the first vertically polarized signal measurement and the first horizontally polarized signal measurement. Likewise, determination of the second representative value at 915 may include obtaining a second vertically polarized signal measurement and a second horizontally polarized signal measurement for each of the one or more signals via the second directional receive antenna, with each of the measurements of the one or more signals by the second directional receive antenna array used to determine the second representative value corresponding to a larger of the second vertically polarized signal measurement and the second horizontally polarized signal measurement or an average of the second vertically polarized signal measurement and the second horizontally polarized signal measurement. As will be appreciated, both representative values may be based on the same algorithm (e.g., both first and second representative values calculated as the larger of the respective polarized signal measurements, or both first and second representative values calculated as the average of the respective polarized signal measurements). However, a hybrid approach is also possible where one of the first and second representative values is calculated as the larger of the respective polarized signal measurements, while the other representative value is calculated as the average of the respective polarized signal measurements.

Referring to FIG. 9, in an example whereby signal strength is used to facilitate region detection, the first and second representative values may each be based on RSSI measurements made by one or more antennas of the first and second directional receive antenna arrays, respectively. For example, the first representative value may correspond to a higher RSSI measurement among vertically and horizontally polarized antennas within the first directional receive antenna array, and the second representative value may correspond to an average of the RSSI measurements by vertically and horizontally polarized antennas within the second directional receive antenna array. The UE may then be determined as being within the region associated with the higher representative value. A degree of difference between the first and second representative values may impact a confidence level of the region detection (e.g., bigger differences are correlated with higher confidence levels). Also, representative values from one or more other directional receive antenna arrays may also impact the confidence level. For example, if two indoor/outdoor oriented differential spatial antenna array pairs both have higher representative values for their respective indoor-oriented directional receive antenna arrays, this increases the confidence level for an indoor region detection of the UE relative to the scenario where only a single indoor/outdoor oriented differential spatial antenna array pair has a higher indoor-oriented representative value.

While FIG. 9 is described with respect to two directional receive antenna arrays that provide measurements used to generate two representative values which are then used to make the region determination at 920, other embodiments can be directed to three or more directional receive antenna arrays that use three or more representative values to make the region determination at 920. In this case, relative to the embodiment described in FIG. 9 above, the apparatus measures (e.g., in parallel with 900-905), via at least one additional directional receive antenna array is coupled to the apparatus, the one or more signals that are transmitted by the one or more transmitters, and to determine (e.g., similar to 910-915) at least one additional representative value for the at least one additional directional receive antenna array based on some or all of the measurements of the one or more signals by the at least one additional directional receive antenna array. The determination of 920 can then further be based on two or more of the first, second and at least one additional representative values.

While FIG. 9 is described above at a high-level, a number of implementation examples related to FIG. 9 will now be described. In particular, the process of FIG. 9 may be implemented so as to achieve polarization diversity, spatial diversity, frequency diversity, temporal diversity (e.g., over time) or any combination thereof.

In a first example, with respect to polarization diversity, the first and second representative values determined at 910-915 may be configured to mitigate one or more problems attributable to polarization uncertainty relative to the one or more transmitters of the UE, referred to herein as “polarization effects”. In an example, one way to mitigate polarization effects is to implement two ports on one or more antenna elements on each directional receive antenna array, with one port being sensitive to vertical polarization and the other being sensitive to horizontal polarization. In this case, each directional receive antenna array produces a signal response level or representative value R_{H} for horizontal ports, and a signal response level or representative value R_{V} for vertical ports. In an example, for directional receive antenna arrays with multiple antenna elements, R_{H} and R_{V} may be constructed by combining (e.g., averaging, etc.) the received signals from multiple antenna elements as discussed above with respect to FIG. 5. A single representative value for the whole directional receive antenna array, R, can be constructed from R_{H} and R_{V}. If the predominant polarization angle θ (with respect to horizontal) of the transmitter can be determined and communicated to the receiver, then an example expression to determine R is R=R_{H} cos(θ)+R_{V} sin(θ). Alternatively, If the transmit polarization is not known then a more general expression can be used to determine R, such as R=max(R_{H},R_{V}) or R=mean(R_{H},R_{V}).

For a differential spatial antenna array pair (or two back-to-back directional receive antenna arrays), there are 4 signal level measurement numbers (e.g., LH, LV, RH and RV), as follows:

TABLE 1

| | “Left” Directional Receive | “Right” Directional Receive |
|---|---|---|
| | Antenna Array | Antenna Array |
| Horizontal | LH | RH |
| port | | |
| Vertical Port | LV | RV |

The directional receive antenna arrays referenced in Table 1 are characterized as “left” and “right” in a context similar to FIG. 4, where the main antenna beams of the respective directional receive antenna arrays are oriented towards different (left/right) directions. For convenience of explanation, the values represented in Table 1 may be based on measurements from multiple antenna elements (each with horizontal and vertical polarization) at each particular directional receive antenna array. In such a case, the respective measurements from the different antenna elements may be averaged or otherwise processed (e.g., lower value discarded, etc.) to obtain the values shown in Table 1.

If the polarization of the transmitted signal is not known, the table column in Table 1 with the largest overall value can be used to determine whether the transmitter is on the “right” side or the “left” side relative to the border between the orientations of the left and right directional receive antenna arrays. For example, if LV contained the largest value out of (LH, RH, LV and RV), then the transmitter is determined to be on the left hand side. However, in an example, if it is known in advance that the transmitted signal was horizontally polarized, then the higher of LH and RH can be used to determine the left/right determination for the transmitter location (even though LV or RV might actually be larger, possibly due to a multipath effect). For example, RH being larger than LH may be used to conclude that the transmitter was on the right hand side.

In the more general case, the transmitted polarization may be a function of horizontally and vertically polarized signals. The transmitter may know its antenna polarization characteristic (by design) and its orientation. The orientation of the transmitter directly alters the apparent polarization of its transmitted signal. In an example, the orientation may be determined using Microelectromechanical systems (MEMs) for elevation or compass direction. If the polarization characteristic and orientation can be determined, this information can be sent to the receiver (or controller) to help the receiver (or controller) to determine the region of the transmitter. One exemplary approach is to determine a predominant polarization angle (from the polarization characteristic and orientation) of the transmitter and send the predominant polarization angle to the receiver. Hence, it can be said that the controller, receiver, or the apparatus more generally, can receive information characterizing a polarization at which the one or more signals are transmitted by the transmitter.

In a second example, spatial diversity can be achieved by combining signals from within multiple elements from the same directional receive antenna array and/or by using signals from two or more directional receive antenna arrays that point towards the same region (e.g., inside or outside)

In a third example, frequency diversity can be achieved whereby the one or more signals measured at 900-905 include a plurality of signals at different frequencies. The first and second representative values can be configured to reflect signal measurements at two or more frequencies (e.g., via averaging, weighted averaging, etc.). For example, some or all of the measurements of the plurality of signals by the first and second directional receive antennas may be averaged over the two or more frequencies to achieve frequency diversity.

In a fourth example, temporal diversity can be achieved by performing 900-905 at different times, and then averaging the results. Averaging samples at different times while otherwise keeping the parameters the same will reduce receiver Gaussian noise but may not significantly impact multipath effects. Also, averaging samples at different times will add to temporal diversity by virtue of intrinsic movements made by the user over time.

FIG. 10 illustrates an example implementation of the process of FIG. 9 in accordance with an embodiment of the disclosure. The process of FIG. 10 is described more specifically with respect to the region-detection system 100 of FIG. 1.

Referring to FIG. 10, the controller 105 connects to a UE and coordinates with the UE to arrange for the UE to transmit one or more signals for a region detection procedure, 1000. In an example, the controller 105 may connect to the UE via a Bluetooth connection, and instruct the UE to transmit the one or more signals at a particular time. The controller 105 may then notify (or turn on) at least the directional receive antenna arrays 1 and 2 (for example, a first directional receive antenna array and a second directional receive antenna array) in order to obtain the signal reception feedback that the controller 105 can use to measure the transmitted signal(s). At 1003, the UE optionally transmits polarization information indicative of its antenna polarization characteristic (e.g., horizontal, vertical, etc.) and orientation (e.g., via a MEMs for elevation or compass direction), as discussed above with respect to FIG. 9. The polarization information sent at 1003 may be used by the controller 105 to determine the first and second representative values, as will be discussed in more detail below with respect to 1015.

Referring to FIG. 10, the UE transmits the one or more signals as instructed, 1005, the directional receive antenna arrays 1 and 2 relay the signal reception feedback to the controller 105 via the coupling 125 and the controller 105 measures the one or more signals, 1010 (e.g., as in 900-905 of FIG. 9). The controller 105 determines a representative value for each of the directional receive antenna arrays 1 and 2, 1015 (e.g., as in 910-915 of FIG. 9). As noted above, the representative values can be averaged over different times, frequencies, ports (to reduce polarization effects, e.g., based on the polarization information optionally received at 1003) and/or spatial regions (e.g., via the directional antenna patterns covering different areas) so as to reduce multipath effects and thereby improve the accuracy of the region determination. The controller 105 then determines whether the UE is within a given region based on the first and second representative values, 1020 (e.g., as in 920 of FIG. 9), and the controller 105 optionally blocks, permits or performs one or more operations based on the determination of 1020, 1025 (e.g., as in 925 of FIG. 9). As will be appreciated, the directional receive antenna arrays 1 and 2 may be deployed as a differential spatial antenna array pair (or a back-to-back paired implementation of directional receive antenna arrays) as in FIG. 6A for example, or in different physical locations as shown in FIG. 7C with respect to the directional receive antenna arrays 745C and 750C in another example. Also, the directional receive antenna arrays 1 and 2 may be deployed with one or more other the directional receive antenna arrays and/or differential spatial antenna arrays pairs, which may improve the accuracy of transmitter region detection.

In an example, the determination of 1020 may be based in part on the first and second representative values while also factoring secondary information. For example, if a car door was opened from outside and then closed from inside, this is suggestive that the user just entered into the car. This knowledge coupled with representative values from 1015 indicating an inside-vehicle likelihood can be used together to increase confidence that the user is inside the car, which can help to make the determination at 1020. Accordingly, data from various sources can be considered with regard to the determination at 1020, and the controller 105 need not limit itself to an evaluation of the first and second representative values from 1015.

Examples of the actions that the controller 105 may optionally implement at 925 of FIG. 9 and 1025 of FIG. 10 are provided below with respect to Table 2:

TABLE 2
Examples of Actions Triggered in Response to Region Determination

| Example | Region Determination | Controller Action |
|---|---|---|
| 1 | UE is outside vehicle | Unlock vehicle; or |
| | | Block vehicle from starting. |
| 2 | UE transitions from outside to | Permit vehicle to start; or |
| | inside vehicle | Automatically start vehicle. |
| 3 | UE is outside office building | Unlock office building doors |
| 4 | UE transitions from outside to | Turn on one or more lights in building. |
| | inside building | |
| 5 | UE enters a particular room of | Start computer; or |
| | building | Turn on light in room |
| 6 | UE directionality of approach | Unlock front or back doors |
| 7 | UE presence detection in | Functionalities made available on the |
| | specific interior areas of the car | UE could be function of its location - |
| | | for instance phone calls will be |
| | | prohibited when UE on or near driver |
| | | seat - whilst allowed when in rear of |
| | | car. |
| 8 | UE determined to be in a | Various |
| | particular region at 1020 based | |
| | on the representative value(s) | |
| | from 1015 coupled with | |
| | secondary information (e.g., car | |
| | door was opened from outside | |
| | and then closed from inside, | |
| | implying that the user just | |
| | entered into the car) | |

With respect to Example 2 of Table 2, a transition of the UE from outside to inside the vehicle (or vice versa) may occur as a result of a state of the UE being monitored over time (e.g., a UE region detection procedure is conducted at a given interval, with the UE determined to have transitioned between regions when a current UE region detection procedure indicates that the UE is in a different region than a previous UE region detection procedure).

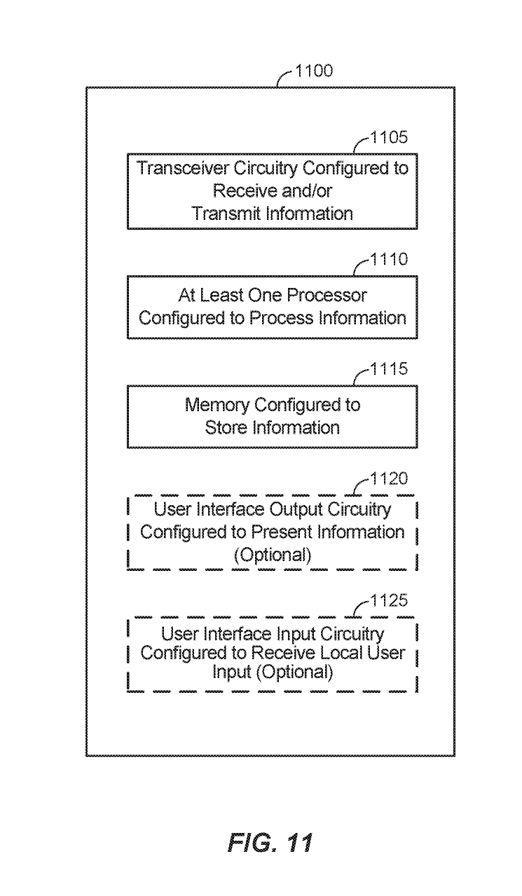

FIG. 11 illustrates a communications device 1100 that includes structural components in accordance with an embodiment of the disclosure. The communications device 1100 can correspond to any of the above-noted communications devices, including but not limited to controller 105 of FIG. 1, controller 700B of FIG. 7B, UEs 800, 800A, 800B or 800C of FIG. 8, and so on. Thus, communications device 1100 can correspond to any electronic device that is configured to communicate with (or facilitate communication with) one or more other entities.

Referring to FIG. 11, the communications device 1100 includes transceiver circuitry configured to receive and/or transmit information 1105. In an example, if the communications device 1100 corresponds to a wireless communications device (e.g., UEs 800-800C, etc.), the transceiver circuitry configured to receive and/or transmit information 1105 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the transceiver circuitry configured to receive and/or transmit information 1105 can correspond to a wired communications interface (e.g., a serial connection, a universal serial bus (USB) or Firewire connection, an Ethernet connection through which the Internet can be accessed, etc.). Thus, if the communications device 1100 corresponds to some type of network-based server, the transceiver circuitry configured to receive and/or transmit information 1105 can correspond to an Ethernet card, in an example, that connects the network-based server to other communication entities via an Ethernet protocol. In a further example, the transceiver circuitry configured to receive and/or transmit information 1105 can include sensory or measurement hardware by which the communications device 1100 can monitor its local environment (e.g., an accelerometer, a temperature sensor, a light sensor, an antenna for monitoring local RF signals, etc.). The transceiver circuitry configured to receive and/or transmit information 1105 can also include software that, when executed, permits the associated hardware of the transceiver circuitry configured to receive and/or transmit information 1105 to perform its reception and/or transmission function(s). However, the transceiver circuitry configured to receive and/or transmit information 1105 does not correspond to software alone, and the transceiver circuitry configured to receive and/or transmit information 1105 relies at least in part upon structural hardware to achieve its functionality. Moreover, the transceiver circuitry configured to receive and/or transmit information 1105 may be implicated by language other than “receive” and “transmit”, so long as the underlying function corresponds to a receive or transmit function. For example, functions such as obtaining, acquiring, retrieving, measuring, etc., may be performed by the transceiver circuitry configured to receive and/or transmit information 1105 in certain contexts as being specific types of receive functions. In another example, functions such as sending, delivering, conveying, forwarding, etc., may be performed by the transceiver circuitry configured to receive and/or transmit information 1105 in certain contexts as being specific types of transmit functions. Other functions that correspond to other types of receive and/or transmit functions may also be performed by the transceiver circuitry configured to receive and/or transmit information 1105.

Referring to FIG. 11, the communications device 1100 further includes at least one processor configured to process information 1110. Example implementations of the type of processing that can be performed by the at least one processor configured to process information 1110 includes but is not limited to performing determinations, establishing connections, making selections between different information options, performing evaluations related to data, interacting with sensors coupled to the communications device 1100 to perform measurement operations, converting information from one format to another (e.g., between different protocols such as .wmv to .avi, etc.), and so on. For example, the at least one processor configured to process information 1110 can include a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the at least one processor configured to process information 1110 may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The at least one processor configured to process information 1110 can also include software that, when executed, permits the associated hardware of the at least one processor configured to process information 1110 to perform its processing function(s). However, the at least one processor configured to process information 1110 does not correspond to software alone, and the at least one processor configured to process information 1110 relies at least in part upon structural hardware to achieve its functionality. Moreover, the at least one processor configured to process information 1110 may be implicated by language other than “processing”, so long as the underlying function corresponds to a processing function. For example, functions such as evaluating, determining, calculating, identifying, etc., may be performed by the at least one processor configured to process information 1110 in certain contexts as being specific types of processing functions. Other functions that correspond to other types of processing functions may also be performed by the at least one processor configured to process information 1110.

Referring to FIG. 11, the communications device 1100 further includes memory configured to store information 1115. In an example, the memory configured to store information 1115 can include at least a non-transitory memory and associated hardware (e.g., a memory controller, etc.). For example, the non-transitory memory included in the memory configured to store information 1115 can correspond to RAM, flash memory, ROM, erasable programmable ROM (EPROM), EEPROM, registers, hard disk, a removable disk, a CD-ROM, or any other form of storage medium known in the art. The memory configured to store information 1115 can also include software that, when executed, permits the associated hardware of the memory configured to store information 1115 to perform its storage function(s). However, the memory configured to store information 1115 does not correspond to software alone, and the memory configured to store information 1115 relies at least in part upon structural hardware to achieve its functionality. Moreover, the memory configured to store information 1115 may be implicated by language other than “storing”, so long as the underlying function corresponds to a storing function. For example, functions such as caching, maintaining, etc., may be performed by the memory configured to store information 1115 in certain contexts as being specific types of storing functions. Other functions that correspond to other types of storing functions may also be performed by the memory configured to store information 1115.

Referring to FIG. 11, the communications device 1100 further optionally includes user interface output circuitry configured to present information 1120. In an example, the user interface output circuitry configured to present information 1120 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communications device 1100. In a further example, the user interface output circuitry configured to present information 1120 can be omitted for certain communications devices, such as network communications devices that do not have a local user (e.g., network switches or routers, remote servers, etc.). The user interface output circuitry configured to present information 1120 can also include software that, when executed, permits the associated hardware of the user interface output circuitry configured to present information 1120 to perform its presentation function(s). However, the user interface output circuitry configured to present information 1120 does not correspond to software alone, and the user interface output circuitry configured to present information 1120 relies at least in part upon structural hardware to achieve its functionality. Moreover, the user interface output circuitry configured to present information 1120 may be implicated by language other than “presenting”, so long as the underlying function corresponds to a presenting function. For example, functions such as displaying, outputting, prompting, conveying, etc., may be performed by the user interface output circuitry configured to present information 1120 in certain contexts as being specific types of presenting functions. Other functions that correspond to other types of storing functions may also be performed by the user interface output circuitry configured to present information 1120.

Referring to FIG. 11, the communications device 1100 further optionally includes user interface input circuitry configured to receive local user input 1125. In an example, the user interface input circuitry configured to receive local user input 1125 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communications device 1100. In a further example, the user interface input circuitry configured to receive local user input 1125 can be omitted for certain communications devices, such as network communications devices that do not have a local user (e.g., network switches or routers, remote servers, etc.). The user interface input circuitry configured to receive local user input 1125 can also include software that, when executed, permits the associated hardware of the user interface input circuitry configured to receive local user input 1125 to perform its input reception function(s). However, the user interface input circuitry configured to receive local user input 1125 does not correspond to software alone, and the user interface input circuitry configured to receive local user input 1125 relies at least in part upon structural hardware to achieve its functionality. Moreover, the user interface input circuitry configured to receive local user input 1125 may be implicated by language other than “receiving local user input”, so long as the underlying function corresponds to a receiving local user function. For example, functions such as obtaining, receiving, collecting, etc., may be performed by the user interface input circuitry configured to receive local user input 1125 in certain contexts as being specific types of receiving local user functions. Other functions that correspond to other types of receiving local user input functions may also be performed by the user interface input circuitry configured to receive local user input 1125.

Referring to FIG. 11, while the configured structural components of 1105 through 1125 are shown as separate or distinct blocks in FIG. 11 that are implicitly coupled to each other via an associated communication bus (not shown expressly), it will be appreciated that the hardware and/or software by which the respective configured structural components of 1105 through 1125 perform their respective functionality can overlap in part. For example, any software used to facilitate the functionality of the configured structural components of 1105 through 1125 can be stored in the non-transitory memory associated with the memory configured to store information 1115, such that the configured structural components of 1105 through 1125 each performs their respective functionality (i.e., in this case, software execution) based in part upon the operation of software stored by the memory configured to store information 1115. Likewise, hardware that is directly associated with one of the configured structural components of 1105 through 1125 can be borrowed or used by other of the configured structural components of 1105 through 1125 from time to time. For example, the at least one processor configured to process information 1110 can format data into an appropriate format before being transmitted by the transceiver circuitry configured to receive and/or transmit information 1105, such that the transceiver circuitry configured to receive and/or transmit information 1105 performs its functionality (i.e., in this case, transmission of data) based in part upon the operation of structural hardware associated with the at least one processor configured to process information 1110.

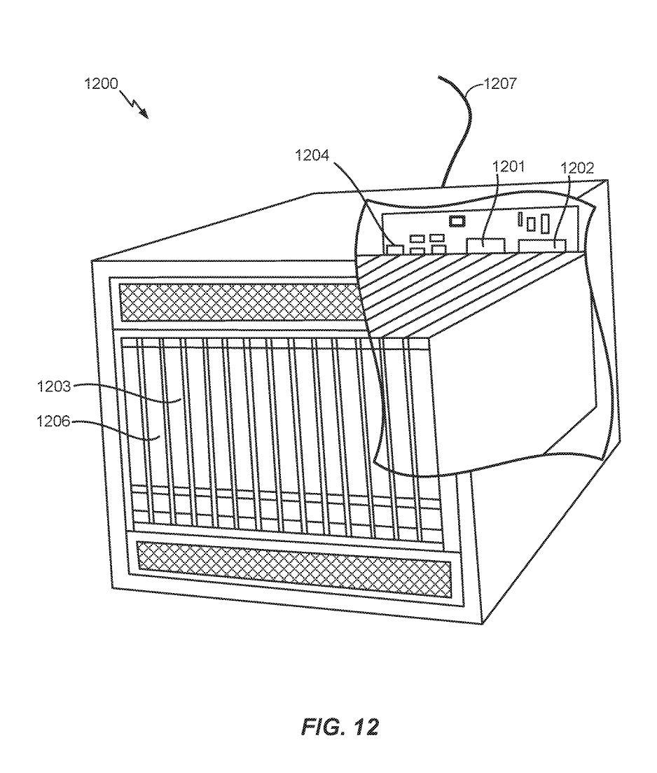

The various embodiments may be implemented on any of a variety of commercially available server devices, such as server 1200 illustrated in FIG. 12. In an example, the server 1200 may correspond to one example configuration of the controller 105 described above. In FIG. 12, the server 1200 includes a processor 1201 coupled to volatile memory 1202 and a large capacity nonvolatile memory, such as a disk drive 1203. The server 1200 may also include a floppy disc drive, compact disc (CD) or DVD disc drive 1206 coupled to the processor 1201. The server 1200 may also include network access ports 1204 coupled to the processor 1201 for establishing data connections with a network 1207, such as a local area network coupled to other broadcast system computers and servers or to the Internet. In context with FIG. 11, it will be appreciated that the server 1200 of FIG. 12 illustrates one example implementation of the communications device 1100, whereby the transceiver circuitry configured to transmit and/or receive information 1105 corresponds to the network access ports 1204 used by the server 1200 to communicate with the network 1207, the at least one processor configured to process information 1110 corresponds to the processor 1201, and the memory configuration to store information 1115 corresponds to any combination of the volatile memory 1202, the disk drive 1203 and/or the disc drive 1206. The optional user interface output circuitry configured to present information 1120 and the optional user interface input circuitry configured to receive local user input 1125 are not shown explicitly in FIG. 12 and may or may not be included therein. Thus, FIG. 12 helps to demonstrate that the communications device 1100 may be implemented as a server, in addition to a UE as in FIG. 8.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a DSP, an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the disclosure, it should be noted that various changes and modifications could be made herein without departing from the scope of the disclosure as defined by the appended claims. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated.

1. A method of determining a region of a user equipment (UE), comprising:
measuring, via a first directional receive antenna array coupled to an apparatus, one or more signals that are transmitted by one or more transmitters of the UE;
measuring, via a second directional receive antenna array coupled to the apparatus, the one or more signals that are transmitted by the one or more transmitters, wherein the first and second directional receive antenna arrays are oriented towards different directions;
determining a first representative value for the first directional receive antenna array based on some or all of the measurements of the one or more signals by the first directional receive antenna array;
determining a second representative value for the second directional receive antenna array based on some or all of the measurements of the one or more signals by the second directional receive antenna array; and
determining whether the UE is within a given region based on the first and second representative values,
wherein the first directional receive antenna is oriented towards an interior region of an enclosed environment and the second directional receive antenna is oriented towards an exterior region of the enclosed environment, wherein the given region is the enclosed environment.

2. The method of claim 1, wherein the first and second directional receive antenna arrays are BLUETOOTH antenna arrays.

3. The method of claim 1, further comprising:
blocking, permitting or performing one or more operations based on whether the UE is determined to be within the given region.

4. The method of claim 1,
wherein the first and second representative values are based on signal strength measurements of the one or more signals by the first and second directional receive antenna arrays, respectively, and
wherein the determining whether the UE is within the given region determines the UE to be inside the given region in response to the first representative value being greater than the second representative value, or wherein the determining whether the UE is within the given region determines the UE to be outside the given region in response to the second representative value being greater than the first representative value.

5. (canceled)

6. The method of claim 1, wherein the enclosed environment is a vehicle and the determining whether the UE is within the given region comprises determining whether the UE is inside or outside of the vehicle.

7. The method of claim 1, wherein the first and second directional receive antenna arrays include substantially non-overlapping antenna patterns.

8. The method of claim 1,
wherein the first directional receive antenna array and a third directional receive antenna array include substantially non-overlapping antenna patterns, and
wherein the substantially non-overlapping antenna patterns cover different regions of the enclosed environment.

9. The method of claim 8,
wherein the first and third directional receive antenna arrays are connected to a radio frequency (RF) switch that is in turn connected to a radio, and
wherein the RF switch is configured to tune to one of the first and third directional receive antenna arrays to facilitate the measurements of the one or more signals by the first and third directional receive antenna arrays.

10. The method of claim 8, wherein the determining whether the UE is within the given region determines whether a current region of the UE is inside of the enclosed environment.

11. The method of claim 1, further comprising:
measuring, via at least one additional directional receive antenna array coupled to the apparatus, the one or more signals that are transmitted by the one or more transmitters;
determining at least one additional representative value for the at least one additional directional receive antenna array based on some or all of the measurements of the one or more signals by the at least one additional directional receive antenna array,
wherein the determining whether the UE is within the given region is based on two or more of the first, second and at least one additional representative values.

12. The method of claim 11,
wherein the at least one additional directional receive antenna array includes multiple directional receive antenna arrays that are deployed throughout a perimeter of a vehicle, and
wherein the determining determines whether the UE is within an interior of the vehicle, an exterior of the vehicle, or a particular portion of the interior or exterior of the vehicle.

13. The method of claim 1, wherein the determining of the first representative value includes:
obtaining a first vertically polarized signal measurement and a first horizontally polarized signal measurement for each of the one or more signals via the first directional receive antenna,
wherein each of the measurements of the one or more signals by the first directional receive antenna array that is used to determine the first representative value corresponds to a larger of the first vertically polarized signal measurement and the first horizontally polarized signal measurement or an average of the first vertically polarized signal measurement and the first horizontally polarized signal measurement.

14. The method of claim 13, wherein the determining of the second representative value includes:
obtaining a second vertically polarized signal measurement and a second horizontally polarized signal measurement for each of the one or more signals via the second directional receive antenna,
wherein each of the measurements of the one or more signals by the second directional receive antenna array that is used to determine the second representative value corresponds to a larger of the second vertically polarized signal measurement and the second horizontally polarized signal measurement or an average of the second vertically polarized signal measurement and the second horizontally polarized signal measurement.

15. The method of claim 1, wherein the one or more signals comprise a plurality of signals over a plurality of frequencies, and wherein the determining of the first representative value includes averaging some or all of the measurements of the plurality of signals by the first directional receive antenna over different frequencies to achieve frequency diversity.

16. The method of claim 1,
wherein a first antenna pattern of the first directional receive antenna array is defined based on beam-forming techniques to have a first degree of spatial coverage,
wherein a second antenna pattern of the second directional receive antenna array is defined based on beam-forming techniques to have a second degree of spatial coverage, and
wherein the given region is defined in part by the first and second degrees of spatial coverage.

17. The method of claim 16,
wherein the first and/or second degrees of spatial coverage correspond to 90 degrees, or
wherein the first and/or second degrees of spatial coverage correspond to 180 degrees.

18. The method of claim 1, further comprising:
receiving information characterizing a polarization at which the one or more signals are transmitted by the UE,
wherein the first and second representative values are determined based on the received polarization information.

19. An apparatus configured to determine a region of a user equipment (UE), comprising:
a first directional receive antenna array capable of measuring one or more signals transmitted by one or more transmitters of the UE;
a second directional receive antenna array capable of measuring the one or more signals transmitted by the one or more transmitters of the UE, wherein the first and second directional receive antenna arrays are oriented towards different directions;
a communications interface coupled to the first directional receive antenna array and the second directional receive antenna array; and
a processor coupled to the communications interface and configured to:
measure, via the first directional receive antenna array, one or more signals that are transmitted by one or more transmitters of the UE;
measure, via the second directional receive antenna array, the one or more signals that are transmitted by the one or more transmitters;
determine a first representative value for the first directional receive antenna array based on some or all of the measurements of the one or more signals by the first directional receive antenna array;
determine a second representative value for the second directional receive antenna array based on some or all of the measurements of the one or more signals by the second directional receive antenna array; and
determine whether the UE is within a given region based on the first and second representative values,
wherein the first directional receive antenna is oriented towards an interior region of an enclosed environment and the second directional receive antenna is oriented towards an exterior region of the enclosed environment, wherein the given region is the enclosed environment.

20. The apparatus of claim 19, wherein the processor is further configured to block, permit or perform one or more operations based on whether the UE is determined to be within the given region.

21. The apparatus of claim 19,
wherein the first directional receive antenna array and a third directional receive antenna array are each oriented towards different regions of the enclosed environment.

22. The apparatus of claim 19, further comprising at least one additional directional receive antenna array coupled to the apparatus capable of measuring the one or more signals transmitted by the one or more transmitters of the UE, wherein the processor is further configured to:
measure, via the at least one additional directional receive antenna array coupled to the apparatus, the one or more signals that are transmitted by the one or more transmitters;
determine at least one additional representative value for the at least one additional directional receive antenna array based on some or all of the measurements of the one or more signals by the at least one additional directional receive antenna array,
wherein the processor is configured to determine whether the UE is within the given region is based on two or more of the first, second and at least one additional representative values.

23. An apparatus configured to determine a region of a user equipment (UE), comprising:
means for measuring, via a first directional receive antenna array coupled to the apparatus, one or more signals that are transmitted by one or more transmitters of the UE;
means for measuring, via a second directional receive antenna array coupled to the apparatus, the one or more signals that are transmitted by the one or more transmitters, wherein the first and second directional receive antenna arrays are oriented towards different directions;
means for determining a first representative value for the first directional receive antenna array based on some or all of the measurements of the one or more signals by the first directional receive antenna array;
means for determining a second representative value for the second directional receive antenna array based on some or all of the measurements of the one or more signals by the second directional receive antenna array; and
means for determining whether the UE is within a given region based on the first and second representative values,
wherein the first directional receive antenna is oriented towards an interior region of an enclosed environment and the second directional receive antenna is oriented towards an exterior region of the enclosed environment, wherein the given region is the enclosed environment.

24. The apparatus of claim 23, wherein the first and second directional receive antenna arrays are BLUETOOTH antenna arrays.

25. The apparatus of claim 23, further comprising:
means for blocking, permitting or performing one or more operations based on whether the UE is determined to be within the given region.

26. (canceled)

27. The apparatus of claim 23,
wherein the first directional receive antenna array and a third directional receive antenna array are each oriented towards different regions of the enclosed environment.

28. A non-transitory computer-readable medium containing instructions stored thereon, which, when executed by an apparatus configured to determine a region of a user equipment (UE), cause the apparatus to perform operations, the instructions comprising:
at least one instruction configured to cause the apparatus to measure, via a first directional receive antenna array coupled to the apparatus, one or more signals that are transmitted by one or more transmitters of the UE;
at least one instruction configured to cause the apparatus to measure, via a second directional receive antenna array coupled to the apparatus, the one or more signals that are transmitted by the one or more transmitters, wherein the first and second directional receive antenna arrays are towards different directions;
at least one instruction configured to cause the apparatus to determine a first representative value for the first directional receive antenna array based on some or all of the measurements of the one or more signals by the first directional receive antenna array;
at least one instruction configured to cause the apparatus to determine a second representative value for the second directional receive antenna array based on some or all of the measurements of the one or more signals by the second directional receive antenna array; and
at least one instruction configured to cause the apparatus to determine whether the UE is within a given region based on the first and second representative values,
wherein the first directional receive antenna is oriented towards an interior region of an enclosed environment and the second directional receive antenna is oriented towards an exterior region of the enclosed environment, wherein the given region is the enclosed environment.

29. The non-transitory computer-readable medium of claim 28, further comprising:
at least one instruction configured to cause the apparatus to block, permit or perform one or more operations based on whether the UE is determined to be within the given region.

30. The non-transitory computer-readable medium of claim 28,
wherein the first and second directional receive antenna arrays are each oriented towards different regions of an enclosed environment, the given region including a portion of the enclosed environment, or
wherein one of the first and second directional receive antenna arrays is oriented towards interior region of the enclosed environment and the other of the first and second directional receive antenna arrays is oriented towards an exterior region of the enclosed environment, the given region including the enclosed environment.
